(19) United States
(12) Patent Application Publication
(10) Pub. No.: US 2012/0055319 A1
(43) Pub. Date: Mar. 8, 2012

(54) Multi-Key Electronic Music Instrument

(76) Inventor: Chia-Yen Lin, Taipei (TW)

(21) Appl. No.: 12/875,134

(22) Filed: Sep. 3, 2010

(51) Int. Cl. G10H 1/32

(52) U.S. Cl. 84/744

(57) ABSTRACT

A multi-key electronic music instrument includes a main body and a circuit board having an integrated circuit (IC). The main body includes operational keys distributed in at least two rows and functional keys. The IC saves at least seven electronic sounds corresponding to music notes of Do, Re, Mi, Fa, So, La and Si in the diatonic scale, functional programs and electronic games. Each of the operational keys corresponds to at least one music note. When one of the operational keys is pressed down, the IC generates a sound corresponding to the music note. When the functional key is pressed, the IC executes the corresponding function in the functional programs, such as raising or lowering a tone of the music note. When the electronic games are played, the operational keys and the function keys are used as controlling keys to play games.

### BACKGROUND OF THE INVENTION

1. Field of the Invention

The present invention relates generally to an apparatus which can be played as a musical instrument and can also be played as an electronic handheld game.

2. The Prior Arts

Although there are many toys available in the market, it is difficult to find a lightweight and portable electronic music instrument for children to play a melody thereon. Generally, a conventional keyboard instrument, such as piano and electronic organ, includes multiple keys and each of the keys corresponds to a specific music note. Therefore, the keyboard instrument needs many keys to cover several music notes. For example, almost every modern piano has 36 black keys and 52 white keys. Inevitably, the keyboard instrument is bulky, and therefore less portable.

### SUMMARY OF THE INVENTION

A primary objective of the present invention is to provide a lightweight and portable electronic music instrument for children to produce sound, compose music, play simple melodies and play various electronic games as well.

In order to achieve the objective, the present invention provides a compact electronic music instrument which can be easily held by children. The electronic music instrument has a plurality of keys including operational keys and functional keys distributed in multiple rows. The rows of keys may be arranged in a matrix layout or a non-matrix layout. Numbers, letters, words, or patterns can be provided on the surfaces of the operational keys and the function keys. Each of the operational keys corresponds to at least one music note, such as Do, Re, Mi, Fa, So, La and Si. The functional keys are adapted for adjusting a tone up or down. When one of the operational keys is pressed down, a sound corresponding to a specific music note is generated. The user can raise or lower the tone of the sound by pressing the functional key. The functional keys may also perform other functions, such as replaying, inputting and setting. Thus, the electronic music instrument according to the present invention allows the children to compose music and play melodies.

According to the present invention, the electronic music instrument includes a circuit board having an integrated circuit (IC). The IC saves at least seven electronic sounds corresponding to music notes in a diatonic scale and has preset functional programs for ascending or descending the tones. When one of the operational keys is pressed, the IC generates a sound corresponding to a specific music note. The user can save a composed melody in the IC and replay it later. In addition, the IC of the electronic music instrument according to the present invention is adapted for saving a plurality of software games. The user can select a game, and uses the operation keys and functional keys to play the selected game.

The electronic music instrument may include a volume switch for turning on or shutting off an audio output of the IC, and adjusting the volume of the audio output. The electronic music instrument further includes a power supply and game selection switch electrically connected to the circuit board. The power supply and game selection switch allows the user to turn on/off the power and select the game software. Moreover, the electronic music instrument may further include a setting and saving switch.

According to an embodiment of the present invention, numbers, letters, words, or patterns are provided on the surfaces of the operational keys and functional keys for the children to memorize or identify music notes.

According to an embodiment of the present invention, the operational keys and the functional keys are arranged in a 3 by 3 matrix. The electronic music instrument may also include more than nine keys that are arranged in a larger matrix. Alternatively, the operational keys and functional keys may also be arbitrarily arranged in a non-matrix layout.

According to an embodiment of the present invention, the circuit board is further provided with a plurality of light emitting units. The light emitting units are adapted for generating various lights of certain colors for certain time intervals corresponding to various electronic sounds.

Comparing with the conventional keyboard instrument, the electronic music instrument according to the present invention needs fewer keys, but still can play music across a wide range. Moreover, the electronic music instrument is also provided with a plurality of games, which are not available in the conventional keyboard instrument.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view showing a multi-key electronic music instrument according to a first embodiment of the present invention;

FIG. 2 is a top view showing the electronic music instrument according to the first embodiment of the present invention;

FIG. 3 is a side view showing the electronic music instrument according to the present invention;

FIG. 4 is a cross-sectional side view illustrating an inner structure of the electronic music instrument according to the present invention;

FIG. 5 illustrates an electrical connection configured by pressing an operational key according to the present invention;

FIG. 6 is a top view showing a multi-key electronic music instrument according to a second embodiment of the present invention, which includes a triangular main body and nine triangular keys; and

FIG. 7 is a top view showing the electronic music instrument according to the first embodiment of the present invention, which includes the operational keys marked with music notes of Do, Re, Mi, Fa, So, La and Si.

### DETAILED DESCRIPTION OF THE PREFERRED EMBODIMENT

The accompanying drawings are included to provide a further understanding of the present invention, and are incorporated in and constitute a part of this specification. The drawings illustrate an embodiment of the present invention and, together with the description, serve to explain the principles of the present invention.

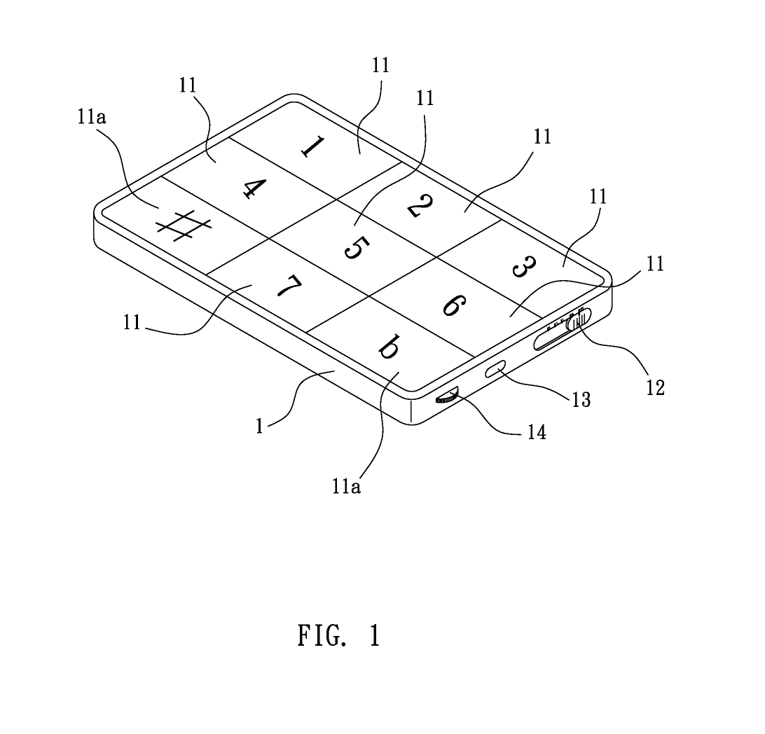

Referring to FIGS. 1 through 4, a multi-key electronic music instrument according to the present invention is configured with a compact size suitable for children to hold and play by hands. The electronic music instrument includes a main body 1 and a circuit board 2 having an integrated circuit (IC) 3 disposed inside the main body 1. The main body 1 includes a plurality of keys with seven operational keys 11 and two functional keys 11a disposed thereon and distributed in a matrix layout. Each of the operational keys 11 has a first conduction portion 111 disposed under the operational key 11, and each of the functional keys 11a has a second conduction portion 111a disposed under the functional key 11a. The operational keys 11 and the functional keys 11a may be members discrete from each other or may be a single layer made of silicone or rubber material. The surface of the single layer is divided into a plurality of pressing zones, which include the operational keys 11 and the functional keys 11a, by printed grids, protruded ridges or recessed grooves.

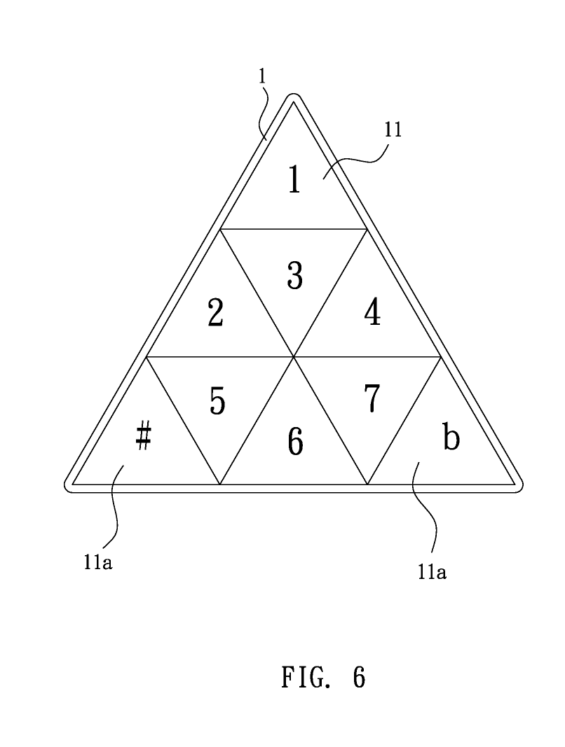

The main body 1 has an inner space to receive the circuit board 2, a battery chamber 16 and a speaker 17. The circuit board 2 is electrically connected with batteries disposed in the battery chamber 16. A plurality of switches, such as a power supply and game selection switch 12, a setting and saving switch 13 and a volume adjusting switch 14, are arranged at a lateral side of the main body 1. The circuit board 2 comprises a plurality of first electrical connection points 21 corresponding to the first conduction portions 111 of the operational keys 11 and a plurality of second electrical connection points 22 corresponding to the second conduction portions 111a of the functional keys 11a. The IC 3 saves at least seven sounds corresponding to seven music notes in a diatonic scale including Do, Re, Mi, Fa, So, La and Si. The IC 3 also includes a plurality of functional programs. Each of the first electrical connection points 21 corresponds to at least one music note. Referring to FIG. 5, when one of the operational keys 11 is pressed to make the first conduction portion 111 of the pressed operational key 11 in contact with the corresponding first electrical connection point 21, the IC 3 generates an electronic sound corresponding to the pressed operational key 11 through the speaker 17. When one of the functional keys 11a is pressed, the IC 3 would run the corresponding functional program. The volume switch 14 can control the IC 3 to turn on and turn off an audio output and adjust the volume of the audio output. The functional programs have functions including ascending tone of the music note, descending tone of the music note, replaying melody, entering melody, setting up functions, etc.

Referring to FIG. 1, when the operational keys 11 marked with numbers 1-7 are pressed, electronic sounds corresponding to music notes of Do, Re, Mi, Fa, So, La and Si are generated respectively. When the functional key 11a marked with “#” or “b” is pressed once, twice and three times, the IC 3 raises or lowers the music note by a semitone, an octave and two octaves respectively. For example, when the functional key 11a marked with “#” or “b” is pressed once and one of the operational keys 11 is immediately pressed thereafter, the electronic sound corresponding to the pressed operational key 11 is generated with a semitone above or below. When the functional key 11a marked with “#” or “b” is consecutively pressed twice and one of the operational keys 11 is immediately pressed thereafter, the electronic sound corresponding to the pressed operational key 11 is generated with an octave above or below. When the functional key 11a marked with “#” or “b” is consecutively pressed three times and one of the operational keys 11 is immediately pressed thereafter, the electronic sound corresponding to the pressed operational key 11 is generated with two octaves above or below.

Furthermore, the functional keys 11a can also perform other functions, such as replay, input and setting. For example, when a functional key 11a corresponding to the replaying function is pressed, the last played music is replayed. When a functional key 11a corresponding to the inputting function is pressed after playing a melody, the played melody is saved in the IC 3. Further, the functional key 11a can set miscellaneous functions, such as setting the rhythm of the music. For example, the music can be played in the rhythm of jazz, heavy metal, pop, rap, rock, etc. The functional key 11a can also set other functions regarding the electronic music instrument.

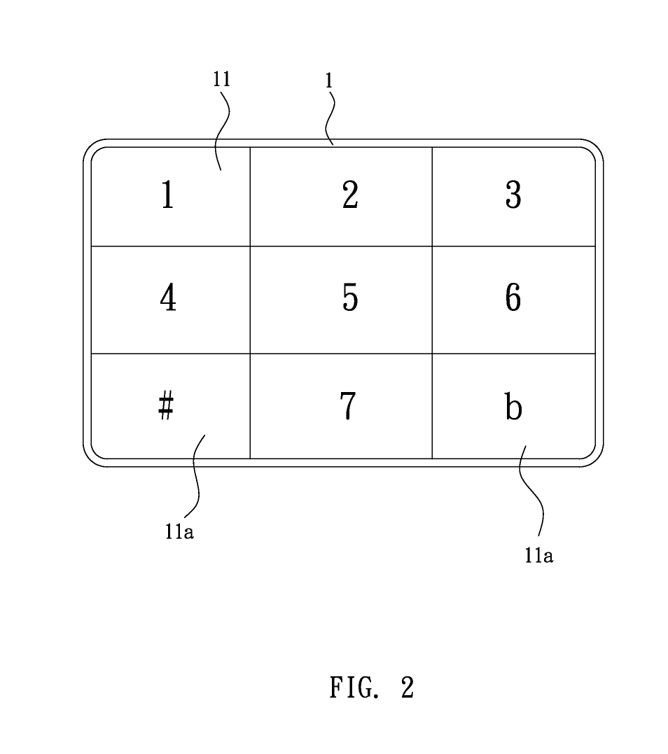

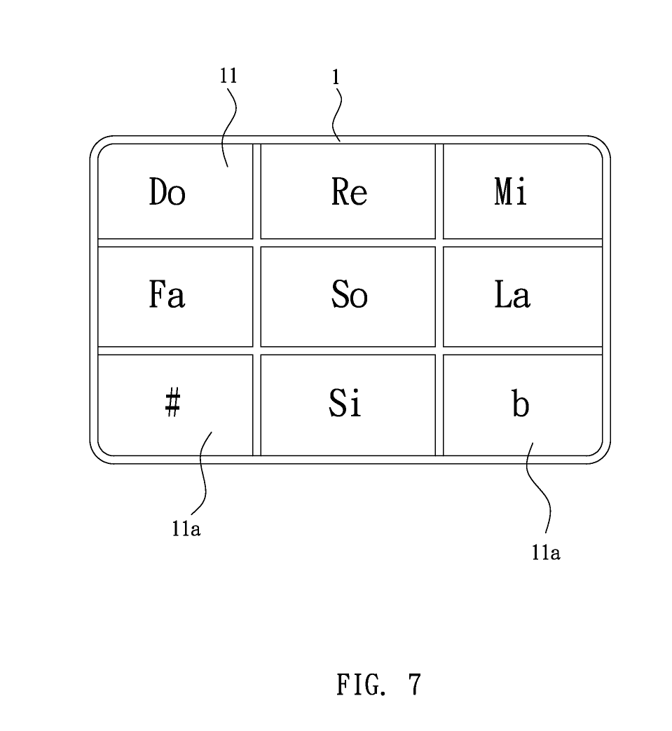

Numbers (i.e. FIGS. 1 and 2), letters, words, or patterns can be provided on the surfaces of the operational keys 11 and the functional keys 11a. As such, the user can easily memorize or identify music notes. Referring to FIG. 7, “Do, Re, Mi, Fa, So, La and Si” representing the music notes are provided on the surfaces of the operational keys 11, and “#” representing a sharp and “b” representing a flat are provided on the surfaces of the functional keys 11a.

The operational keys 11 and the functional keys 11a mentioned above are arranged in a 3 by 3 matrix. The operational keys 11 are distributed in at least two rows. Based on the 3 by 3 matrix layout, the electronic music instrument may increase or reduce the number of the keys according to the requirement. The operational keys 11 and the functional keys 11a are not limited to nine keys. The electronic music instrument may have only eight keys arranged in a 3 by 3 matrix with one element missing. The electronic music instrument may have ten keys that include nine keys in a 3 by 3 matrix and one key positioned adjacent to the matrix.

The operational keys 11 corresponding to the music notes of Do, Re, Mi, Fa, So, La and Si may be arranged in various orders. The operational keys 11 corresponding to the music notes of Do, Re and Mi may be arranged from left to right or from right to left at a top row of the 3 by 3 matrix. The operational keys 11 corresponding to the music notes of Fa, So and La may be arranged from left to right or from right to left at a middle row of the matrix. The operational key 11 corresponding to the music note of Si may be arranged at a bottom row of the matrix.

In addition, for aesthetic perception, the circuit board 2 may further include a plurality of light emitting units 15 (e.g., a light emitting diode, LED) disposed corresponding to the operational keys 11 and functional keys 11a. The light emitting units 15 are adapted for emitting various lights of certain colors for certain time intervals corresponding to the music. The emitted light transmits through the operational keys 11 and the functional keys 11a made of light transmitting materials for achieving a brilliant visual effect.

Facilitated with the setting and saving switch 13, the user can practice to compose simple melodies and learn music when playing a game. For example, there are functional programs saved in the IC 3. After a user presses the setting and saving switch 13, the IC 3 is in an editing state. The user plays a melody by pressing operational keys 11 and the functional keys 11a, and then presses the setting and saving switch 13 again to save the melody. The preset functional program would save the played melody in the IC 3. Thus, the user can practice to compose the music. The user can replay the saved melody by pressing two certain operational keys 11, two certain functional keys 11a, or one of the operational keys 11 with one of the functional keys 11a at the same time. Then, the preset functional program saved in the IC 3 would replay the saved melody.

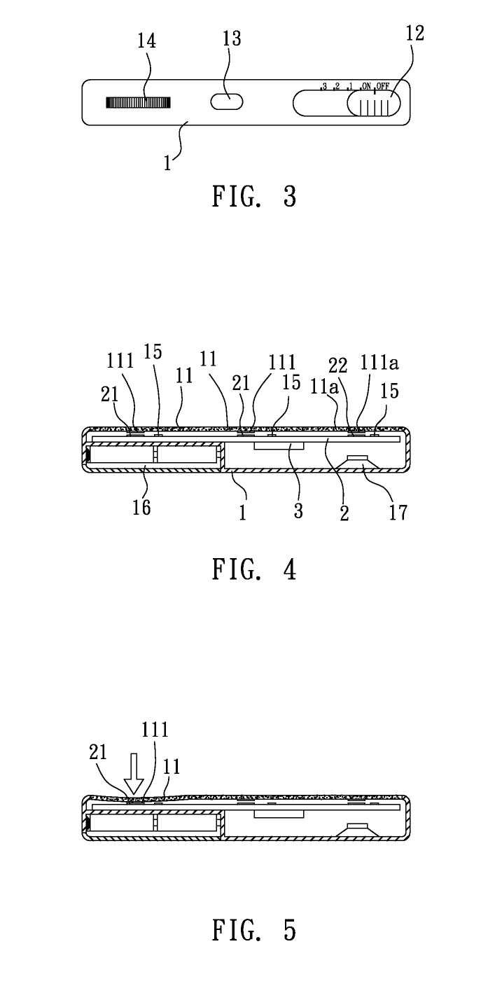

For better entertainment, the IC 3 may further include software of at least one electronic game, such as “Whack the Mole”, “Bingo”, “Memory game”, “Tic-Tac-Toe”, “Carousel Lamp”, etc. When the electronic games are played, the operational keys 11 and the functional keys 11a work as control keys. Referring to FIG. 3, the power supply and game selection switch 12 is provided at the lateral side of the main body 1. The power supply and game selection switch 12 is adapted for turning on/off the power and selecting one of the games to play.

For example, after selecting the “Whack the Mole” game, the operational key 11 and functional key 11a randomly flash and may also generate an electronic sound. When the user successfully presses the flashing key before it extinguishes, it is taken as the user's successful hit of a mole and a different sound is generated as a confirmation of hit.

For example, after selecting the “Bingo” game, the user presses at least one operational key 11 or functional key 11a, and then presses the setting and saving switch 13 to save the previous selection. The user presses the setting and saving switch 13 again, and then the operational keys 11 or the functional keys 11a emit light one by one in a predetermined sequence for a random time interval. Then the operational keys 11 and the functional keys 11a stop flashing. At least one key 11, 11a is randomly picked by the preset program and the picked key 11, 11a emits light. If the key 11, 11a picked by the preset program is the same as the previously selected key 11, 11a pressed by the user, the user wins the Bingo game.

For example, after the “Memory Game” is selected, the operational keys 11 flash one by one in a randomly generated sequence and the sound of the corresponding music notes is generated. The flashing stops after a time interval. The user is expected to press the operational keys 11 in the same sequence of the previous flashed operational keys 11 and the generated sounds. If the user presses the operational keys 11 in a correct sequence, the user can play the next round of the Memory Game with a higher level that has more flashed operational keys 11. If the user presses the operational keys 11 in an incorrect sequence, the user can play the next round of the Memory Game with a lower level that has less flashed operational keys 11.

For example, after the “Tic-Tac-Toe” game is selected, a first player selects to press one of the operational keys 11 or functional keys 11a, and then the pressed operational key 11 or functional key 11a emits light of a first color. Then, a second player selects to press one of the other operational keys 11 or functional keys 11a, and the pressed operational key 11 or functional key 11a emits light of a second color. The two players alternatively press the other operational keys 11 and functional keys 11a in accordance with the foregoing order until one of the two players successfully links the operational keys 11 or functional keys 11a on the main body 1 into a straight line.

Further, for example, if the “Carousel Lamp” is selected, the operational keys 11 and the functional keys 11a sequentially flash and the sounds are generated for aesthetic and hearing entertainment. The operational keys 11 and the functional keys 11a extinguish after a predetermined time interval.

Referring to FIG. 6, an electronic music instrument according to a second embodiment of the present invention includes a triangular main body 1. The main body 1 includes nine triangular keys, which have seven operational keys 11 marked with numbers 1-7 and two functional keys 11a marked with “#” and “b”, disposed thereon. When the operational keys 11 marked with numbers 1-7 are pressed, electronic sounds corresponding to the musical notes of Do, Re, Mi, Fa, So, La and Si in a diatonic scale are generated respectively. When the functional key 11a marked with “#” or “b” is pressed once and one of the operational keys 11 is immediately pressed thereafter, the electronic sound corresponding to the pressed operational key 11 is generated with a semitone above or below. When the functional key Ila marked with “#” or “b” is consecutively pressed twice and one of the operational keys 11 is immediately pressed thereafter, the electronic sound corresponding to the pressed operational key 11 is generated with an octave above or below. When the functional key 11a marked with “#” or “b” is consecutively pressed three times and one of the operational keys 11 is immediately pressed thereafter, the electronic sound corresponding to the pressed operational key 11 is generated with two octaves above or below. The operational keys 11 corresponding to the music note of Do, Re, Mi, Fa, So, La and Si are arranged from a top row to a bottom row and from the left to the right. The operational keys 11 corresponding to the music note of Do, Re, Mi, Fa, So, La and Si may also be arranged from a top row to a bottom row and from the right to the left.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A multi-key electronic music instrument, comprising:
a main body including at least seven operational keys and at least one functional key disposed thereon, each of the operational keys having a first conduction portion and the functional key having a second conduction portion, the seven operational keys respectively corresponding to music notes of Do, Re, Mi, Fa, So, La and Si in a diatonic scale, and the seven operational keys being distributed in at least two rows; and
a circuit board having an integrated circuit (IC), the circuit board being disposed in the main body and comprising at least seven first electrical connection points respectively corresponding to the first conduction portions of the operational keys and at least one second electrical connection point corresponding to the second conduction portion of the functional key, the integrated circuit saving at least seven electronic sounds corresponding to the music notes of Do, Re, Mi, Fa, So, La and Si in a diatonic scale, and a plurality of functional programs;
wherein each of the first electrical connection points corresponds to at least one of the music notes and the second electrical connection point corresponds to the functional programs, when the first conduction portion of one of the operational keys electrically contacts with the corresponding first electrical connection point, the integrated circuit generates the electronic sound of the corresponding music note, and when the second conduction portion of the functional key electrically contacts with the corresponding second electrical connection point, the integrated circuit executes at least one of the functional programs.

2. The multi-key electronic music instrument as claimed in claim 1, wherein the functional programs saved in the integrated circuit comprise a program adapted for raising or lowering a tone of the music notes.

3. The multi-key electronic music instrument as claimed in claim 1, wherein the functional programs saved in the integrated circuit comprise a program adapted for replaying a music saved in the integrated circuit.

4. The multi-key electronic music instrument as claimed in claim 1, wherein the functional programs saved in the integrated circuit comprise a program adapted for selecting a function of the electronic music instrument.

5. The multi-key electronic music instrument as claimed in claim 1, wherein numbers, letters, words, or patterns are provided on surfaces of the operational keys and the functional key.

6. The multi-key electronic music instrument as claimed in claim 5, wherein the words provided on the operational keys are Do, Re, Mi, Fa, So, La and Si.

7. The multi-key electronic music instrument as claimed in claim 1, wherein the integrated circuit saves software of at least one electronic game, the operational keys and the functional key serve as controlling keys for playing the electronic game, and the main body further comprises a power supply and game selection switch electrically connected to the circuit board for turning on and turning off power, and selecting the electronic game to play.

8. The multi-key electronic music instrument as claimed in claim 1, wherein the main body comprises a volume switch electrically connected to the circuit board for controlling the integrated circuit to turn on and turn off an audio output and adjust volume of the audio output.

9. The multi-key electronic music instrument as claimed in claim 7, wherein the main body further comprises a setting and saving switch electrically connected to the circuit board, when the setting and saving switch is pressed a first time, the operational keys and the functional key are at an editing state for playing music or the electronic game, and when the setting and saving switch is pressed a second time, the music or the electronic game is saved.

10. The multi-key electronic music instrument as claimed in claim 1, wherein the circuit board comprises a plurality of light emitting units adapted for generating lights of predetermined colors for predetermined time intervals corresponding to the electronic sounds.

11. The multi-key electronic music instrument as claimed in claim 1, wherein the main body includes seven operational keys and two functional keys arranged in a three by three matrix.

12. The multi-key electronic music instrument as claimed in claim 1, wherein the main body has a rectangular contour, and the operational keys and the functional key are shaped in rectangles.

13. The multi-key electronic music instrument as claimed in claim 1, wherein the main body has a triangular contour, and the operational keys and the functional key are shaped in triangles.

14. The multi-key electronic music instrument as claimed in claim 13, wherein the operational keys corresponding to the music notes of Do, Re, Mi, Fa, So, La and Si are arranged from a top row to a bottom row and from left to right or arranged from the top row to the bottom row and from the right to the left.

15. The multi-key electronic music instrument as claimed in claim 11, wherein the operational keys corresponding to the music notes of Do, Re and Mi are arranged from left to right at a top row of the matrix, the operational keys corresponding to the music notes of Fa, So and La are arranged from the left to the right at a middle row of the matrix and the operational key corresponding to the music note of Si is arranged at a bottom row of the matrix.

16. The multi-key electronic music instrument as claimed in claim 11, wherein the operational keys corresponding to the music notes of Do, Re and Mi are arranged from right to left at a top row of the matrix, the operational keys corresponding to the music notes of Fa, So and La are arranged from the right to the left at a middle row of the matrix and the operational key corresponding to the music note of Si is arranged at a bottom row of the matrix.

17. The multi-key electronic music instrument as claimed in claim 11, wherein the operational keys corresponding to the music notes of Do, Re and Mi are arranged from left to right at a top row of the matrix, the operational keys corresponding to the music notes of Fa, So and La are arranged from the right to the left at a middle row of the matrix and the operational key corresponding to the music note of Si is arranged at a bottom row of the matrix.

18. The multi-key electronic music instrument as claimed in claim 11, wherein the operational keys corresponding to the music notes of Do, Re and Mi are arranged from right to left at a top row of the matrix, the operational keys corresponding to the music notes of Fa, So and La are arranged from the left to the right at a middle row of the matrix and the operational key corresponding to the music note of Si is arranged at a bottom row of the matrix.
